(19) United States
(12) Patent Application Publication
(10) Pub. No.: US 2012/0031445 A1
(43) Pub. Date: Feb. 9, 2012

(54) Cleaning Apparatus For Use With Dentures And Other Dental Appliances

(76) Inventor: Darrell Prevail, Sioux City, IA (US)

(21) Appl. No.: 12/852,584

(22) Filed: Aug. 9, 2010

(51) Int. Cl. B08B 3/00; B08B 3/08; B08B 3/10

(52) U.S. Cl. 134/57 R; 134/93

(57) ABSTRACT

A cleaning apparatus for use with dentures and other dental appliances includes a housing having a tablet storage area and a tank positionable in and removable from the housing, the tank being sized to respectively receive the dentures and other dental appliances. The cleaning apparatus includes a dispenser to move a tablet from the tablet storage area to the tank. A stirring assembly includes a first portion in the housing and a second portion in the tank. The first portion includes a first magnet, the second portion includes a grate, a rotor, and a second magnet fixed to the rotor and complementary to the first magnet. Rotation of the first magnet about an axis of rotation causes the second magnet to rotate about the axis of rotation when the tank is positioned in the housing.

### BACKGROUND OF THE INVENTION

This invention relates generally to dental accessories and, more particularly, to an apparatus for use in cleaning dentures and other dental appliances.

It is well known that dentures must be cleaned regularly in order to be maintained in a sanitary condition and in a manner suitable to be worn daily in a person's mouth. Cleaning false teeth is a nightly ritual of placing the teeth into a container along with an effervescing tablet so that the teeth are cleaned overnight. With such routine cleaning, a wearer of false teeth may be confident that the teeth will last for many years and be clean and attractive. Unfortunately, the task of nightly cleaning may be inconvenient and may not provide the desired level of cleaning.

Various devices have been proposed in the prior art for nightly cleaning of dentures. Although assumably effective for their intended purposes, the existing proposals and products to not provide an ability to automatically dispense an effervescing tablet at a user-selectable time later than when the dentures are placed into the storage container, for easily removing a storage tank from the remainder of the device housing for cleaning, or for automatically stirring the mixture of water and cleaning tablet so as to enhance the cleaning process.

Therefore, it would be desirable to having a denture cleaning device that overcomes the disadvantages and limitations of the devices proposed in the prior art.

### SUMMARY OF THE INVENTION

A cleaning apparatus for use with dentures and other dental appliances includes a housing having a tablet storage area and a tank positionable in and removable from the housing, the tank being sized to respectively receive the dentures and other dental appliances. The cleaning apparatus includes a dispenser to move a tablet from the tablet storage area to the tank. A stirring assembly includes a first portion in the housing and a second portion in the tank. The first portion includes a first magnet, the second portion includes a grate, a rotor, and a second magnet fixed to the rotor and complementary to the first magnet. Rotation of the first magnet about an axis of rotation causes the second magnet to rotate about the axis of rotation when the tank is positioned in the housing.

Therefore, a general object of this invention is to provide an apparatus for use in cleaning dentures.

Another object of this invention is to provide an apparatus for cleaning dentures, as aforesaid, that includes a tank that is positionable in and removable from a housing.

Still another object of this invention is to provide an apparatus for cleaning dentures, as aforesaid, having a tablet dispenser configured to automatically dispense a tablet into the tank.

Yet another object of this invention is to provide an apparatus for cleaning dentures, as aforesaid, having a timer such that a user may set a time when a tablet is to be dispensed into the tank.

A further object of this invention is to provide an apparatus for cleaning dentures, as aforesaid, that automatically stirs water in the tank to enhance the cleaning of dentures.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an apparatus for cleaning dentures according to a preferred embodiment of the present invention.

FIG. 2 is an exploded view of the denture cleaning apparatus as in FIG. 1;

FIG. 3a is a side view of the denture cleaning apparatus as in FIG. 1 with the tray in a fully extended configuration;

FIG. 3b is a side view of the denture cleaning apparatus as in FIG. 1 with the tray in a partially extended configuration;

FIG. 3c is a side view of the denture cleaning apparatus as in FIG. 1 with the tray in a generally configuration;

FIG. 4a is a front view of the denture cleaning apparatus as in FIG. 1;

FIG. 4b is a sectional view taken along line 4b-4b of FIG. 4a;

FIG. 5a is a perspective view of the dispenser removed from the housing as in FIG. 2 illustrated a configuration of being loaded;

FIG. 5b is another perspective view of the dispenser illustrating a configuration of being loaded and ready for use; and

FIG. 5c is another perspective view of the dispenser in which a tablet is being dispensed.

### DESCRIPTION OF THE PREFERRED EMBODIMENT

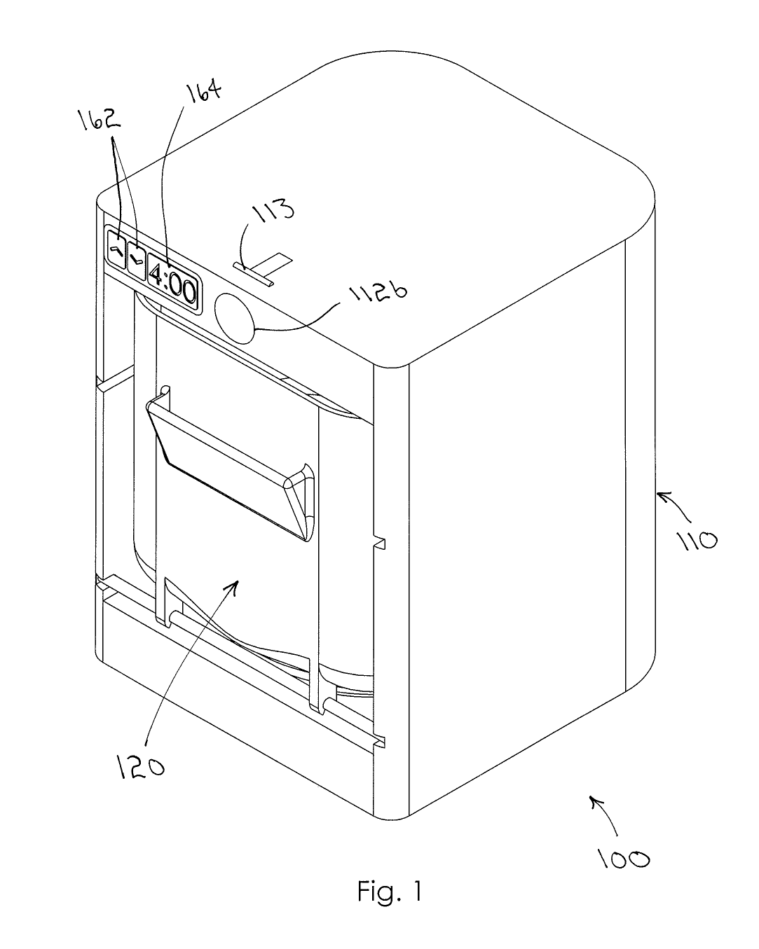

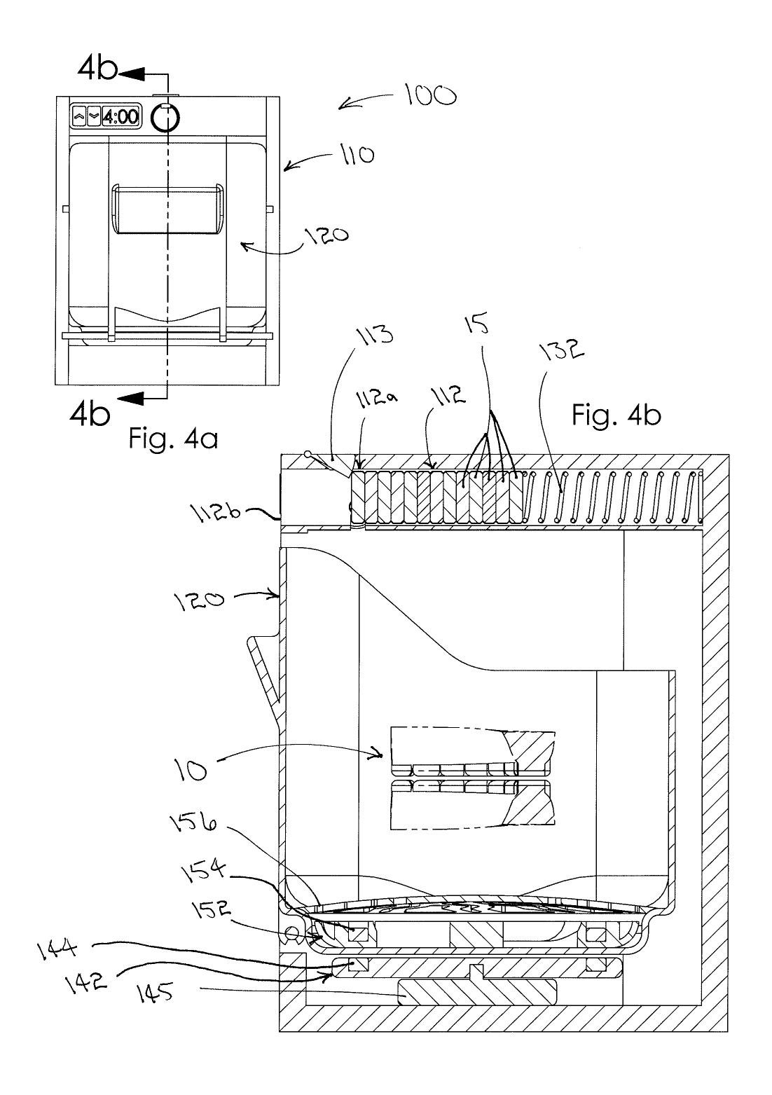

Cleaning apparatus according to the present invention will now be described in detail with reference to FIGS. 1 through 5c of the accompanying drawings. More particularly, a cleaning apparatus 100 according to one embodiment for use with dentures 10 (FIG. 4b) and other dental appliances such as Invisalign® braces and mouth guards (e.g., dental night guards, dental guards for use in athletics, etc.) includes a housing 110, a tank 120 sized to receive at least one dental appliance 10, a dispenser 130, and a stirring assembly 140.

The housing 110 is specifically shown in FIGS. 1, 2, and 4b, and includes a tablet storage area 112 (FIG. 4b) configured to store at least one cleaning tablet 15. The tablet storage area 112 has a staging area 112a and a loading port 112b for passing the cleaning tablets 15 from outside the housing 110 to the storage area 112, and a stop 113 restricts movement of the tablets 15 in the storage area 112 from travelling past the staging area 112a to the loading port 112b. However, the stop 113 allows the tablets 15 to pass from the loading port 112b to the tablet storage area 112. The stop 113 may be, for example, a member that freely pivots over a limited area. The housing 110 may be constructed of plastic, metal, and/or any other appropriate material.

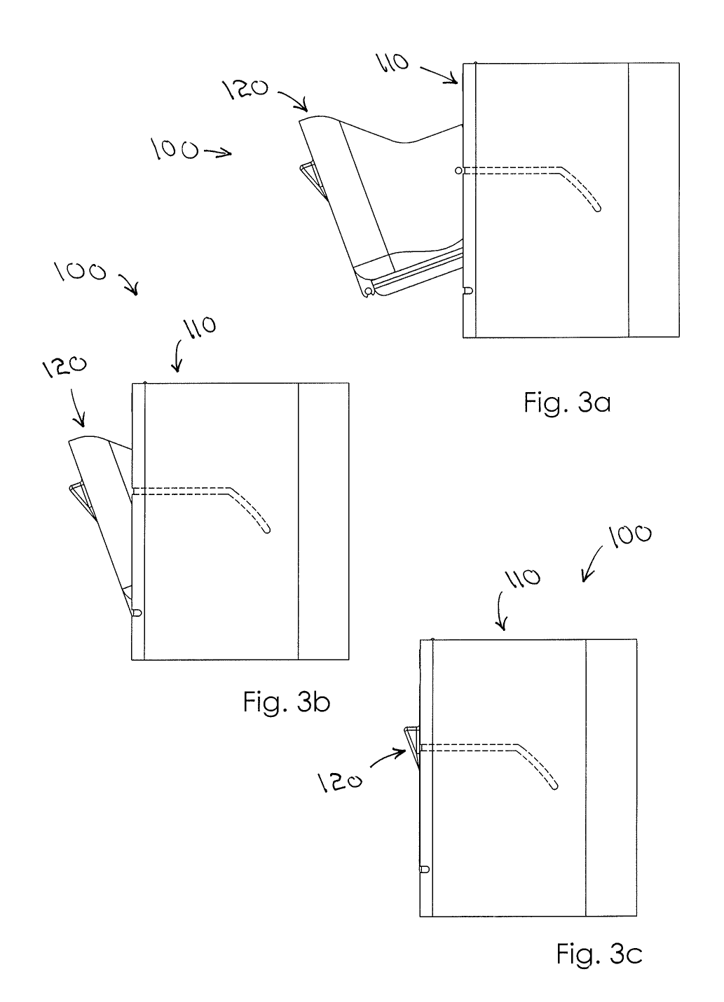

As shown in FIGS. 1 through 4b, the tank 120 is positionable in and removable from the housing 110. The tank 120 may be positionable in the housing 110 in various manners, such as being movable between retracted, partially extended, and fully extended configurations; however, it may be desirable for the tank 120 to be rotatably and slidably received in the housing 110 (FIGS. 3a through 3c). When positioned in the housing 110, the tank 120 is beneath the staging area 112a (FIG. 4b). Though not shown in the drawings, the housing 110 may include a water reservoir in communication with the tank 120 for providing water to the tank 120. Various materials may be used to construct the tank 120, such as plastic, metal, and glass.

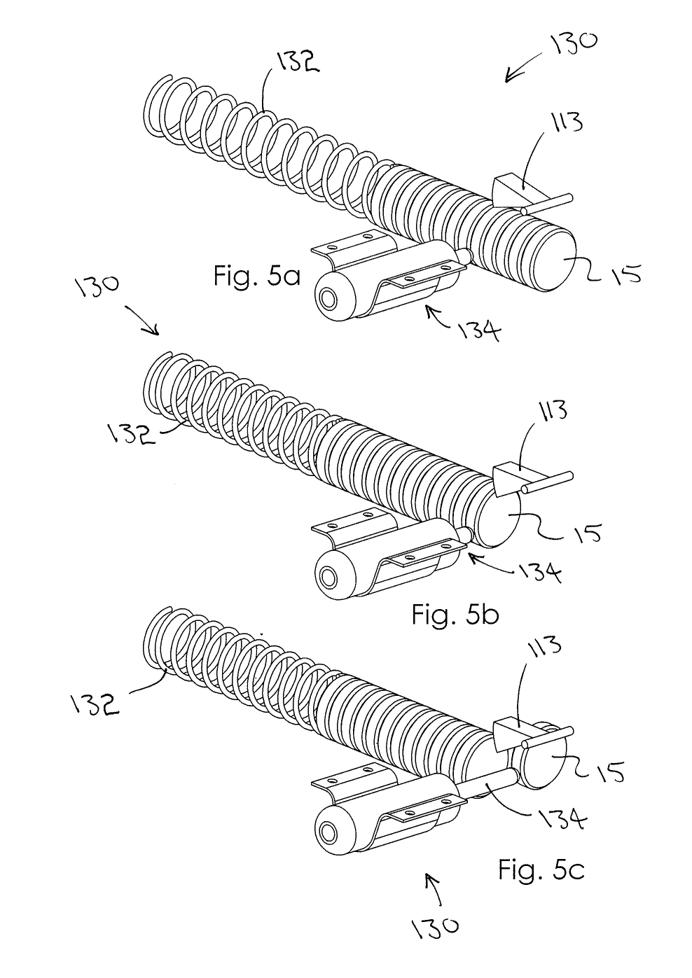

Turning to the dispenser 130, the dispenser 130 is operable to move a tablet 15 from the tablet storage area 112 (and specifically the staging area 112a) to the tank 120. The dispenser 130 may, for example, include a biasing member 132 (e.g., a spring) and a push member 134 (e.g., a solenoid). The biasing member 132 biases the tablets 15 in the storage area 112 toward the staging area 112a (FIG. 4b); the push member 134 is movable to respectively push the tablets 15 from the staging area 112a toward the tank 120 (FIGS. 5a through 5c).

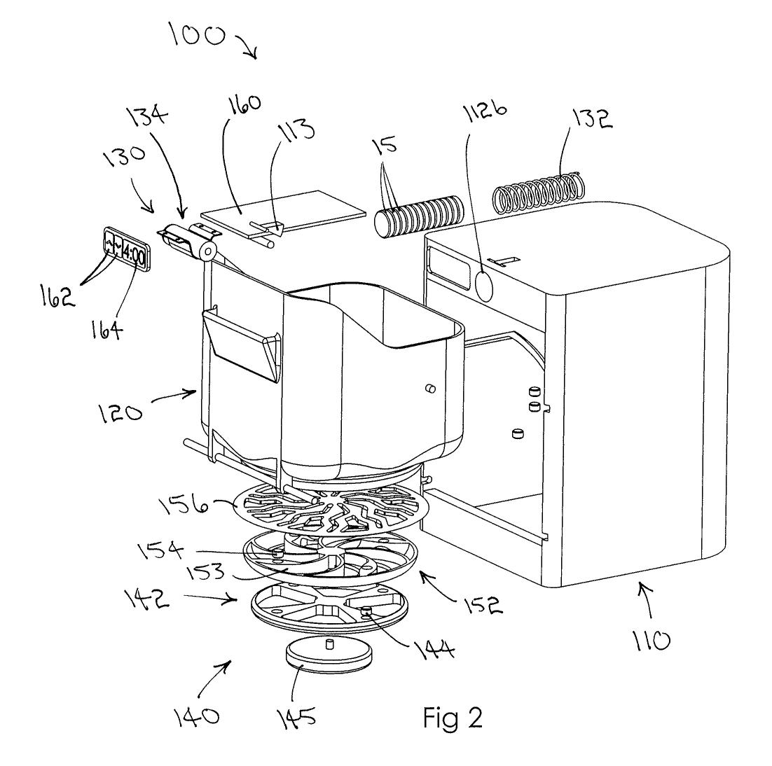

The stirring assembly 140 (FIGS. 2 and 4b) has a first portion 142 coupled to the housing 110 and a second portion 152 in the tank 120. The first portion 142 has a magnet 144 that is rotatable about an axis of rotation, and a motor 145 may be in communication with the magnet 144 to selectively rotate the magnet 144 about the axis of rotation. The second portion 152 has a rotor 153, a magnet 154 fixed to the rotor 153, and a grate 156 shielding the rotor 153. It may be desirable for the rotor 153, the magnet 154, and the grate 156 to be removable from the tank 120. The magnet 154 is complementary to the magnet 144 (e.g., such that the two magnets 154, 144 are drawn together). More particularly, rotation of the magnet 144 about the axis of rotation causes the magnet 154 to rotate about the same axis of rotation when the tank 120 is positioned in the housing 110.

Attention now being specifically directed to FIGS. 1 and 2, a processor 160 is in data communication with a user input 162, a timer 164, the dispenser 130, and the motor 145. The processor 160 has programming to actuate the dispenser 130 at a time provided by the user input 162 and determined by the timer 164, and programming to actuate the motor 145 upon occurrence of a triggering event. A triggering event may be, for example, actuation of the dispenser 130, an amount of time after actuation of the dispenser 130, et cetera.

In use, the user may select a time using the user input 162 and place the dentures or other dental appliance 10 in the tank 120 (FIG. 4b). If the housing 110 includes a water reservoir, water from the water reservoir may be positioned in the tank 120 (either automatically or upon receiving an input from the user, such as through moving a switch); otherwise, the user may fill the tank 120 with water (e.g., when placing the dentures or other dental appliance 10 in the tank 120). The tank 120 is positioned in the housing 110 beneath the staging area 112a.

At least one cleaning tablet 15 is pushed through the loading port 112b and into the storage area 112 (FIGS. 4b and 5a). Once the tablets 15 are in the storage area 112 past the staging area 112a, the stop 113 restricts movement of the tablets 15 from exiting through the loading port 112b (FIGS. 4b and 5b). The biasing member 132 biases the tablets 15 in the storage area 112 toward the staging area 112a (FIG. 4b). As shown in FIG. 5c, the push member 134 is movable to respectively push the tablets 15 from the staging area 112a toward the tank 120. And as noted above, the dispenser 130 may be actuated by the processor 160 at a time provided by the user input 162 and determined by the timer 164; or the user may otherwise actuate the dispenser 130 to move a cleaning tablet 15 to the tank 120. Providing the cleaning tablet 15 to the tank 120 allows the dental appliance 10 to be cleaned by the cleaning tablet 15. It may be advantageous for the processor 160 to actuate the dispenser 130, such as while the user is sleeping, so that the dental appliance 10 is recently cleaned when the user awakes (or at another selected time).

To enhance the cleaning ability of the cleaning tablet 15, the amount of contact between the dental appliance 10 and the cleaning solution created from the cleaning tablet 15 and the water may be increased. Actuation of the motor 145 (e.g., by the processor 160) causes the magnet 144 to rotate about the axis of rotation, and the rotation of the magnet 144 causes the complementary magnet 154 to rotate about the axis of rotation. Rotation of the magnet 154 in turn causes the rotor 153 to rotate beneath the grate 156 and agitate the cleaning solution in the tank 120. Because of the interaction between the magnets 144, 154, the rotor 153 is rotated without direct, physical contact between the motor 145 and the rotor 153.

To retrieve the dental appliance 10, the tank 120 may be moved (e.g., as shown in FIGS. 3a through 3c) or removed from the housing 110. The cleaning fluid may then be discarded, and the tank 120 may be cleaned. To fully clean the tank 120, the grate 156, the rotor 153, and therefore the associated magnet 154 may be removed from the tank 120.

It is understood that while certain forms of this invention have been illustrated and described, it is not limited thereto except insofar as such limitations are included in the following claims and allowable functional equivalents thereof.

1. A cleaning apparatus for use with dentures and other dental appliances, the cleaning apparatus comprising:
a housing having a tablet storage area;
a tank positionable in and removable from said housing, said tank being sized to respectively receive said dentures and other dental appliances;
a dispenser to move a tablet from said tablet storage area to said tank; and
a stirring assembly having a first portion in said housing and a second portion in said tank; said first portion having a first magnet; said second portion having a grate, a rotor, and a second magnet fixed to said rotor and complementary to said first magnet; rotation of said first magnet about an axis of rotation causing said second magnet to rotate about said axis of rotation when said tank is positioned in said housing.

2. The cleaning apparatus of claim 1, further comprising a motor in communication with said first magnet to selectively rotate said first magnet about said axis of rotation.

3. The cleaning apparatus of claim 2, further comprising:
a user input;
a timer; and
a processor in data communication with said user input, said timer, said dispenser, and said motor; said processor having programming to actuate said dispenser at a time provided by said user input and determined by said timer; said processor having programming to actuate said motor upon occurrence of a triggering event.

4. The cleaning apparatus of claim 3, wherein said dispenser includes:
a biasing member biasing said tablet in said tablet storage area toward a staging area in said tablet storage area;
a stop restricting movement of said tablet in said tablet storage area from travelling past said staging area to a loading port, said stop allowing said tablet to pass from said loading port to said tablet storage area; and
a push member movable to push said tablet from said staging area toward said tank.

5. The cleaning apparatus of claim 4, wherein said biasing member is a spring and said push member is a solenoid.

6. The cleaning apparatus of claim 5, wherein said grate, said rotor, and said second magnet are removable from said tank.

7. The cleaning apparatus of claim 6, wherein said housing includes a water reservoir in communication with said tank for providing water to said tank.

8. The cleaning apparatus of claim 1, wherein said dispenser includes:
a biasing member biasing said tablet in said tablet storage area toward a staging area;
a stop restricting movement of said tablet in said tablet storage area from travelling past said staging area to a loading port, said stop allowing said tablet to pass from said loading port to said tablet storage area; and
a push member movable to push said tablet from said staging area toward said tank.

9. The cleaning apparatus of claim 8, wherein:
said biasing member is a spring;
said push member is a solenoid; and
said grate, said rotor, and said second magnet are removable from said tank.

10. The cleaning apparatus of claim 9, further comprising:
a user input;
a timer; and
a processor in data communication with said user input, said timer, and said dispenser; said processor having programming to actuate said dispenser at a time provided by said user input and determined by said timer.

11. A cleaning apparatus for use with dentures and other dental appliances, the cleaning apparatus comprising:
a housing having a tablet storage area, a staging area, a loading port for passing at least one cleaning tablet from outside said housing to said tablet storage area, and a stop restricting movement of said at least one tablet in said tablet storage area from travelling past said staging area to said loading port; said stop allowing said at least one tablet to pass from said loading port to said tablet storage area;
a tank positionable in and removable from said housing, said tank being sized to respectively receive said dentures and other dental appliances, said tank being beneath said staging area when positioned in said housing;
a dispenser to move a respective tablet from said staging area to said tank; and
a stirring assembly having a first portion coupled to said housing and a second portion in said tank; said first portion having a first magnet; said second portion having a grate, a rotor shielded by said grate, and a second magnet fixed to said rotor and complementary to said first magnet; rotation of said first magnet about an axis of rotation causing said second magnet and said rotor to rotate about said axis of rotation when said tank is positioned in said housing.

12. The cleaning apparatus of claim 11, further comprising a motor in communication with said first magnet to selectively rotate said first magnet about said axis of rotation.

13. The cleaning apparatus of claim 12, further comprising:
a user input;
a timer; and
a processor in data communication with said user input, said timer, said dispenser, and said motor; said processor having programming to actuate said dispenser at a time provided by said user input and determined by said timer; said processor having programming to actuate said motor upon occurrence of a triggering event.

14. The cleaning apparatus of claim 13, wherein said grate, said rotor, and said second magnet are removable from said tank.

15. The cleaning apparatus of claim 14, wherein said dispenser includes:
a biasing member biasing said at least one tablet in said tablet storage area toward said staging area; and
a push member movable to respectively push said at least one tablet from said staging area toward said tank.

16. The cleaning apparatus of claim 15, wherein said biasing member is a spring and said push member is a solenoid.

17. The cleaning apparatus of claim 11, wherein said dispenser includes:
a biasing member biasing said at least one tablet in said tablet storage area toward said staging area; and
a push member movable to respectively push said at least one tablet from said staging area toward said tank.

18. The cleaning apparatus of claim 17, wherein:
said biasing member is a spring;
said push member is a solenoid; and
said grate, said rotor, and said second magnet are removable from said tank.
